(19) United States
(12) Patent Application Publication
(10) Pub. No.: US 2004/0205580 A1
(43) Pub. Date: Oct. 14, 2004

(54) Method and system for document management

(75) Inventors: Valerio De Angelis, Goleta, CA (US); Srikrishna Illendula, Santa Barbara, CA (US); Matthew Elmer Smith, Bakersfield, CA (US); Satya Kumar Kalidindi, Goleta, CA (US); Jonathan David Sullivan, Burlington, VT (US)

Correspondence Address: WHITE & CASE LLP, PATENT DEPARTMENT, 1155 AVENUE OF THE AMERICAS, NEW YORK, NY, 10036, US

(73) Assignee: MINDFLASH TECHNOLOGIES, INC.

(21) Appl. No.: 10/155,596

(22) Filed: May 23, 2002

(51) Int. Cl. G06F 17/24

(52) U.S. Cl. 715/513; 715/501.1

(57) ABSTRACT

A document management system (10) includes a content repository (14) for storing a file, a management system (12) for monitoring and managing the file in the content repository (14), and an authoring portal (15). The authoring portal (15) embeds ActiveX controls in a document, parses the document, and converts the document into an HTML file. The authoring portal (15) further generates JavaScript codes, thereby enabling the content repository (14) to dynamically respond the input of a user and provide the user with feedback without accessing a database associated with the document. The codes also enable the content repository (14) to dynamically adjust the sequence in which the documents are presented to the user in response to the inputs from the user.

### FIELD OF THE INVENTION

The present invention relates in general to document management and specifically to the creation and conversion of online documents.

### BACKGROUND OF THE INVENTION

Online documentation is widely used in both Internet and Intranet environments. For example, many corporations and organizations use online documentation to provide online learning and/or training opportunities for their employees or members. An online learning system typically includes a learning management system (LMS) and a learning content management system (LCMS). Through the LMS, the corporation can monitor and manage the learning processes of the employees. The LMS may have user databases such as, for example, human resource data, customer relation data, billing data, etc. The LMS functions as a bridge between the users and the LCMS. The LCMS is a repository of the online documents, e.g., the learning materials, in a standard compliant format. The documents can be generated either externally, e.g., by commercial content providers or internally, e.g., by corporation employees or consultants.

The documents are typically generated using widely available applications such as, for example, WordPerfect, Microsoft Word, PowerPoint, Excel, Dream Weaver, Acrobat, etc. The generated documents need to be converted into a standard compliant format and placed on the LCMS so that they can interact with the LMS. This format conversion process is complicated, time consuming, and cost inefficient. In addition, the known conversion processes are unreliable because they often inadvertently introduce mistakes into the documents.

Accordingly, it would be advantageous to have a document management system and a document management process for converting documents generated using various kinds of applications into files in a standard compliant format. It is desirable for the system and the process to be cost efficient and reliable. It would be of further advantage if the system and the process are compatible with various existing and future operating systems.

### SUMMARY OF THE INVENTION

An aspect of the present invention is providing an authoring tool and a method for providing and managing documents in a standard compliant format. In one aspect of the present invention, the authoring tool and the method convert documents generated using various kinds of applications into files in a standard compliant format. A specific aspect of the present invention is to provide an authoring tool and a method that are cost efficient and reliable. A benefit in accordance with an embodiment of the present invention is that the authoring tool and the method are compatible with various existing and future operating systems.

An authoring tool in accordance with an embodiment of the present invention performs a process that converts a document to a trackable content file. The document can be generated by various kinds of applications, e.g., commercially available WordPerfect, Word, PowerPoint, Excel, Acrobat, etc. According to one embodiment, the trackable content file is stored on a content repository on an online learning network. The trackable content file communicates with a management system, and exchanges data therewith.

The authoring tool in accordance with an embodiment of the present invention includes a library of ActiveX controls. The conversion process converts a document into a hyper link markup language (HTML) or extensible markup language (XML) file with ActiveX controls embedded therein. The converted file is parsed to create a standard format compliant file, e.g., a Sharable Content Object Reference Model (SCORM) compliant file. Other types of files that can be created by the authoring tool include Automatic Intercept Communications Controller (AICC) compliant files, trackable files, files for offline delivery, etc.

In accordance with an aspect of the present invention, the conversion process generates codes for establishing a dynamic database-driven web page. The codes, which are JavaScript codes in accordance with a specific embodiment of the present invention, enable the content repository to dynamically respond to the input of a user and provide the user with feedback without accessing a database associated with the document. The codes also enable the content repository to dynamically adjust the sequence in which the documents and files are presented to the user in response to the inputs from the user.

The authoring tool in accordance with one aspect of the present invention provides flexibility in the choice of file format used to generate the documents. The conversion process automatically generates codes for processing questions in the document. By using the codes, the content repository interacts with the user without the need of accessing or processing the database associated with the document. The codes also enable the content repository to dynamically present the content to the user.

### BRIEF DESCRIPTION OF THE DRAWINGS

FIG. 1 is a block diagram of a document management system in accordance with the present invention; and

FIG. 2 is a flow chart of a document management process in accordance with the present invention.

### DETAILED DESCRIPTION OF VARIOUS EMBODIMENTS

Various embodiments of the present invention are described hereinafter with reference to the figures. It should be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in any other embodiments of the present invention.

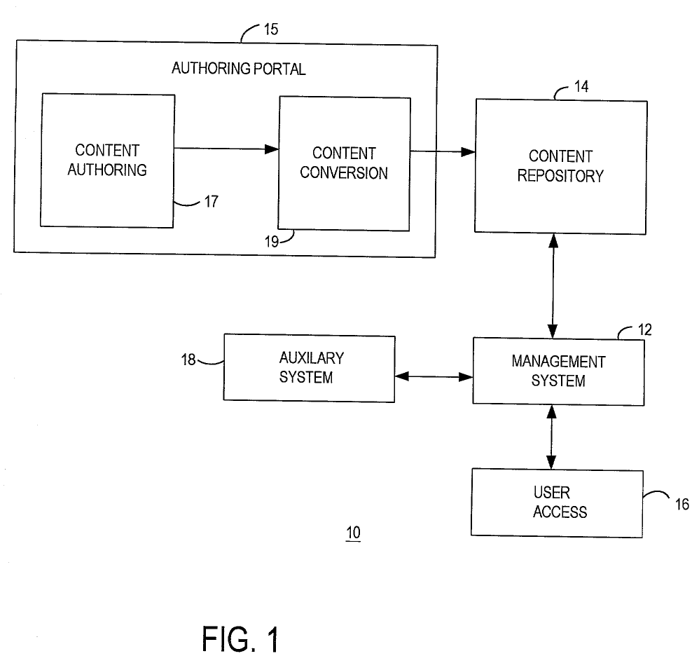

FIG. 1 is a block diagram showing a document management system 10 in accordance with an embodiment of the present invention. By way of example, document management system 10 is a server of online documentation that provides users with learning or training opportunities. Server 10 includes a management system 12 and a content repository 14. Management system 12 has the capabilities of controlling and monitoring the access of server 10 by users through a user access unit 16. Management system 12 is coupled to an auxiliary system 18 that contains information to facilitate the operation of management system 12. Content repository 14 stores content to be accessed by the users. In accordance with an embodiment of the present invention, content repository 14 includes such contents as instructional materials, quiz questions and their correct answers, etc., and is also referred to as a learning content management system (LCMS) or a document repository. Management system 12, which is also referred to as a learning management system (LMS), monitors how many times a user has accessed an instructional material, how many and which quiz questions the user has answered correctly, etc. Management system 12 may use human resource information, billing information, customer relation information from auxiliary system 18 in controlling and monitoring the user access of server 10 through user access unit 16.

Server 10 also includes an authoring portal 15, which is also referred to as an authoring tool, for providing the contents to content repository 14. Authoring portal 15 includes a content authoring unit 17 and a content conversion unit 19. In accordance with an embodiment of the present invention, a content provider creates a document, e.g., using a commercially available application such as WordPerfect, Microsoft Word, Excel, PowerPoint, Dream Weaver, Frame Maker, etc. The created document is loaded onto authoring portal 15 through content authoring unit 17. Content conversion unit 19 converts the document into a standard compliant format and loads the converted document to content repository 14. In accordance with one embodiment of the present invention, authoring unit 17 includes a library of ActiveX controls.

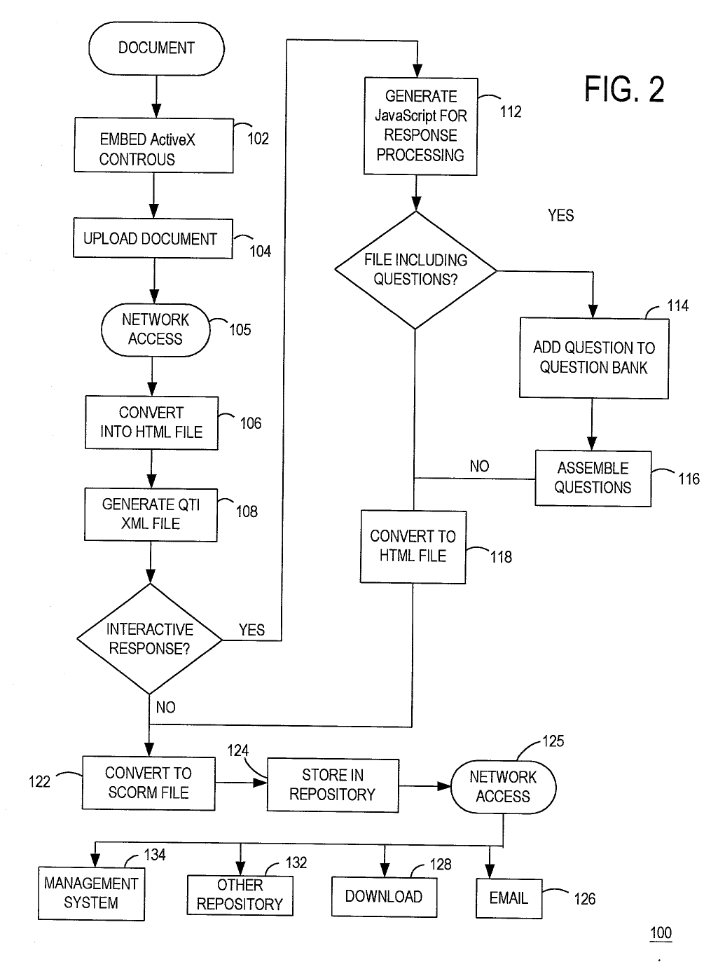

FIG. 2 is a block diagram illustrating a document management or conversion process 100 in accordance with an embodiment of the present invention. By way of example, authoring portal 15 in server 10 of FIG. 1 uses conversion process 100 to convert a document into a standard compliant format and loads the converted file to content repository 14.

In a step 102, content authoring unit 17 in authoring portal 15 adds the ActiveX controls to the document file as embedded controls. In a step 104, authoring portal 15 uploads the document file onto server 10 through a network access 105. By way of example, network access 105 is an Internet access. However, this is not intended as a limitation on the present invention; other network accesses that can serve as network access 105 include, but are not limited to, intranet access, Ethernet access, local area network (LAN) access, etc.

Next in a step 106, content conversion unit 19 in authoring portal 15 converts the file into a hyper link markup language (HTML) file with ActiveX controls embedded therein. In a step 108, authoring portal 15 uses the ActiveX controls embedded in the HTML file to generate an Extensible Markup Language (XML) file. According to one aspect of the present invention, authoring portal 15 converts the document into a trackable file compliant with the Instructional Management System (IMS) standard.

If the file includes interactive responses to user inputs, authoring portal 15, in a step 112, generates JavaScript codes for response processing. Specifically, if the document file includes quiz questions, the quiz questions are added to the question bank in a step 114. In a step 116, the questions in the question bank are assembled and/or sequenced.

In accordance with an embodiment of the present invention, authoring portal 15 generates JavaScript codes complaint with the IMS Question and Test Specification. For example, when the document is a quiz question with multiple choice answers, the JavaScript codes generated by authoring portal 15 are capable of processing the quiz results and calculating test scores of a user. The generated codes enable the content repository 14 in server 10 to process the test results without accessing the database that includes the actual answers to the quiz questions.

By way of example, a document includes quiz questions that have a plurality of answer choices. Depending on the subject matter of the questions, the contents of the answer choices may be either simple and short or complicated and long. Each answer choice may be correct, incorrect, or marginally correct. The question may require the user to complete such tasks as sorting or arranging the choices in a particular order, selecting one or more choices, matching one choice with another choice, etc. A quiz taker may receive high scores for making correct choices, low or even punitive negative scores for making wrong choices, or intermediate scores for making partially correct or marginally correct choices. According to one aspect of the present invention, authoring portal 15 generates the codes that are specific to each quiz question in the document. The codes take all possible choices for the quiz question into consideration and assign a score for each possible choice or each possible combination of choices.

In another example, the document includes a plurality of quiz questions. The sequence of the quiz questions presented to a quiz taker may preferably depend on how well the quiz taker answers the quiz questions. If the quiz taker performs poorly in answering a quiz question, it would be preferred to present him with the learning materials or additional quiz questions that may help him in understanding the subject matters covered in the quiz question. In accordance with an embodiment, authoring portal 15 also generates the codes that enable this adaptive learning process.

In a step 118, authoring portal 15 converts the XML file with the question bank back into an HTML file. By way of example, Extensible Style Language Transformation (XSLT) can be used to transform the XML file into the HTML file.

In a step 122, authoring portal 15 converts the HTML file into a standard format compliant file, e.g., a Sharable Content Object Reference Model (SCORM) compliant file. Other types of files that can be created by authoring portal 15 include Automatic Intercept Communications Controller (AICC) compliant files, trackable files, files for offline delivery, etc. In accordance with an embodiment of the present invention, document conversion step 122 also adds wrapping JavaScript codes to the document. In an aspect of the present invention, the document conversion step 122 generates dynamic database-driven web pages.

In a step 124, authoring portal 15 stores the converted file in content repository 14 of server 10 shown in FIG. 1. Through a network access 125, the file stored in content repository 14 can be sent to a user by E-mail in response to a user request (step 126). The file can also be downloaded from content repository 14 (step 128). Through network access 125, a file on content repository 14 can further be sent to the content repositories on other servers (step 132). A file on content repository 14 can also be accessed through management system 12 in server 10 (step 134).

When a user seeks to access the document, the codes generated by authoring portal 15 and accompanying the document allow content repository 14 to respond to the user input and provide feedback to the user. The codes further enable content repository 14 to adjust the sequence in which the materials are presented to the user in response to the input from the user. For example, in a learning environment, the codes generated by authoring portal 15 enable content repository 14 to package the learning materials for different users, e.g., beginning, intermediate, and advanced, by combining the learning materials into different sequences.

In accordance with an embodiment of the present invention, the response of content repository 14 to the inputs of a user may also depend on the identity of the user. By way of example, management system 12 on server 10 may instruct content repository 14 to present a user, who is a corporate executive, with the material without requiring the user to answer quiz questions. On the other hand, management system 12 may instruct content repository 14 to present a user, who is an applicant for a position in the corporation, with the quiz questions in the related fields without presenting him with learning materials or feedback. Content repository 14 may also present different quiz questions to a user depending on his answer to the previous quiz questions.

By now it should be appreciated that an authoring tool and a method for providing documents in a standard compliant format have been provided. The authoring tool and the method convert documents generated using various kinds of applications into files in a standard compliant format. In accordance with an embodiment of the present invention, document conversion and code generation processes are implemented through executing software programs in a standard signal processor, e.g., a microprocessor, a central processing unit, etc. Therefore online document management system of the present invention is cost efficient and reliable. Further, the authoring tool and the method are compatible with various existing and future operating systems.

While various embodiments of the present invention have been described with reference to the drawings, these are not intended to limit the scope of the present invention, which is set forth in the appending claims. Various modifications of the above described embodiments can be made by those skilled in the art after browsing the specification of the subject application. These modifications are within the scope and true spirit of the present invention.

1. A document management process, comprising the steps of:
parsing a document;
converting the document into a standard compliant format;
generating a plurality of codes specific to the document for response processing; and
loading the document in the standard compliant format and the plurality of codes to a content repository.

2. The process of claim 1, the step of parsing a document including parsing the document generated using an application selected from the group consisting of Microsoft Word, PowerPoint, Excel, Word Perfect, Dream Weaver, Frame Maker, and Acrobat.

3. The process of claim 1, the step of parsing a document including embedding a plurality of ActiveX controls in the document.

4. The process of claim 3, the step of converting the document including converting the document into a HyperText Markup Language (HTML) file.

5. The process of claim 4, further comprising the step of generating an Extensible Markup Language (XML) file in response to the plurality of ActiveX controls embedded in the document.

6. The process of claim 1, the step of converting the document including converting the document into a Sharable Content Object Reference Model (SCORM) compliant file.

7. The process of claim 1, the step of converting the document including converting the document into an Automatic Intercept Communications Controller (AICC) compliant file.

8. The process of claim 1, the step of converting the document including converting the document into a trackable file.

9. The process of claim 1, the step of generating a plurality of codes including generating a plurality of JavaScript codes.

10. The process of claim 1, the step of generating a plurality of codes including generating the plurality of codes for creating a dynamic web page.

11. The process of claim 1, the step of generating a plurality of codes including generating the plurality of codes that enable the content repository to respond to an input without accessing a database associated with the document.

12. The process of claim 1, the step of generating a plurality of codes including generating the plurality of codes that enable the content repository to present the documents in an adaptive manner.

13. The process of claim 1, the step of generating a plurality of codes further including generating the plurality of codes that enable the content repository to present the documents to a user in accordance with an identity of the user.

14. The process of claim 1, the step of loading the document including loading the document to the content repository through a network access.

15. The process of claim 1, further comprising the step of accessing the document in the content repository through a network access.

16. A document authoring process, comprising the steps of:
embedding a plurality of ActiveX controls in a document;
converting the document into a first HyperText Markup Language (HTML) file with the plurality of ActiveX controls embedded therein;
generating an Extensible Markup Language (XML) file in response to the plurality of ActiveX controls;
generating a plurality of codes specific to the document for response processing; and
converting the XML file to a second HTML file; and
loading the second HTML file to a content repository.

17. The document authoring process of claim 16, wherein the step of converting the XML file to a second HTML file includes converting the XML file to the second HTML file through Extensible Style Language Transformation (XSLT).

18. The document authoring process of claim 16, further comprising the step of converting the second HTML file into a Sharable Content Object Reference Model (SCORM) compliant file.

19. A document management system, comprising:
a content repository for storing a file;
a management system coupled to said content repository and having capabilities of monitoring and managing the file in said content repository; and
an authoring portal coupled to said content repository, said authoring portal being configured to perform a document authoring process by:
converting the document into a standard compliant format;
generating a plurality of codes specific to the document for response processing; and
loading the document in the standard compliant format and the plurality of codes to said content repository.

20. The document management system claim 19, said authoring portal being configured to perform a document authoring process further by generating a plurality of JavaScript codes that enable said content repository to respond to a user input without accessing to a database associated with the document.
